(19) United States
(12) Patent Application Publication
(10) Pub. No.: US 2024/0284312 A1
(43) Pub. Date: Aug. 22, 2024

(54) USER EQUIPMENT POLICY CONTROL WITH POLICY CONTROL FUNCTION RESELECTION

(71) Applicant: APPLE INC., Cupertino, CA (US)

(72) Inventors: Vivek Gupta, San Jose, CA (US); Haijing Hu, Los Gatos, CA (US); Sridhar Prakasam, Fremont, CA (US)

(73) Assignee: APPLE INC., Cupertino, CA (US)

(21) Appl. No.: 18/416,636

(22) Filed: Jan. 18, 2024

Related U.S. Application Data
(60) Provisional application No. 63/446,960, filed on Feb. 20, 2023.

(51) Int. Cl. H04W 48/16; H04W 8/12

(52) U.S. Cl. CPC H04W 48/16; H04W 8/12

(57) ABSTRACT

The present application relates to devices and components, including apparatus, systems, and methods for providing the user equipment (UE) state indication to the policy control function (PCF).

### CROSS-REFERENCES TO OTHER APPLICATIONS

This application claims priority to U.S. Provisional Application No. 63/446,960, for “USER EQUIPMENT POLICY CONTROL WITH POLICY CONTROL FUNCTION RESELECTION,” filed on Feb. 20, 2023, which is herein incorporated by reference in its entirety for all purposes.

### TECHNICAL FIELD

This application generally relates to cellular communication networks and, in particular, to technologies for managing user equipment (UE) policies at a core network's policy control function (PCF).

### BACKGROUND

Several network functions (NFs) may provide services related to a wireless cellular network's data plane or control plane operations. For example, a policy control function (PCF) may provide policies to a user equipment (UE), such as selecting a wireless local access network (WLAN) and proximity services (ProSe). It is desired that the PCF keep accurate and updated information regarding the configured policies at the UE.

### BRIEF DESCRIPTION OF THE DRAWINGS

FIG. 1 illustrates a network environment in accordance with some embodiments.

FIG. 2 illustrates a signaling diagram in accordance with some embodiments.

FIG. 3 illustrates a table in accordance with some embodiments.

FIG. 4 illustrates a block diagram in accordance with some embodiments.

FIG. 5 illustrates a signaling diagram in accordance with some embodiments.

FIG. 6 illustrates an operational flow/algorithmic structure in accordance with some embodiments.

FIG. 7 illustrates an operational flow/algorithmic structure in accordance with some embodiments.

FIG. 8 illustrates an operational flow/algorithmic structure in accordance with some embodiments.

FIG. 9 illustrates an operational flow/algorithmic structure in accordance with some embodiments.

FIG. 10 illustrates an operational flow/algorithmic structure in accordance with some embodiments.

FIG. 11 illustrates a user equipment in accordance with some embodiments.

FIG. 12 illustrates a network node in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth, such as particular structures, architectures, interfaces, and/or techniques, in order to provide a thorough understanding of the various aspects of some embodiments. However, it will be apparent to those skilled in the art having the benefit of the present disclosure that the various aspects of the various aspects may be practiced in other examples that depart from these specific details. In certain instances, descriptions of well-known devices, circuits, and methods are omitted so as not to obscure the description of the various aspects with unnecessary detail. For the purposes of the present document, the phrase “A or B” means (A), (B), or (A and B), and the phrase “based on A” means “based at least in part on A,” for example, it could be “based solely on A,” or it could be “based in part on A.”

The following is a glossary of terms that may be used in this disclosure.

The term “circuitry” as used herein refers to, is part of, or includes hardware components, such as an electronic circuit, a logic circuit, a processor (shared, dedicated, or group), or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), and/or digital signal processors (DSPs), that are configured to provide the described functionality. In some aspects, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these aspects, the combination of hardware elements and program code may be referred to as a particular type of circuitry.

The term “processor circuitry” as used herein refers to, is part of, or includes circuitry capable of sequentially and automatically carrying out a sequence of arithmetic or logical operations; or recording, storing, or transferring digital data. The term “processor circuitry” may refer to an application processor; baseband processor; a central processing unit (CPU); a graphics processing unit; a single-core processor; a dual-core processor; a triple-core processor; a quad-core processor; or any other device capable of executing or otherwise operating computer-executable instructions, such as program code; software modules; or functional processes.

The term “interface circuitry,” as used herein, refers to, is part of, or includes circuitry that enables the exchange of information between two or more components or devices. The term “interface circuitry” may refer to one or more hardware interfaces; for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to and may be referred to as client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device, including a wireless communications interface.

The term “computer system,” as used herein, refers to any type of interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to a computer, storage, or network resources provided by physical hardware element(s). A “virtualized resource” may refer to a computer, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services and may include computing or network resources. System resources may be considered as a set of coherent functions, network data objects, or services accessible through a server where such system resources reside on a single host or multiple hosts and are clearly identifiable.

The term “channel,” as used herein, refers to any tangible or intangible transmission medium used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link,” as used herein, refers to a connection between two devices for the purpose of transmitting and receiving information.

The terms “instantiate,” “instantiation,” and the like, as used herein, refer to the creation of an instance. An “instance” also refers to a concrete occurrence of an object, which may occur, for example, during the execution of program code.

The term “connected” may mean that two or more elements at a common communication protocol layer have an established signaling relationship with one another over a communication channel, link, interface, or reference point.

The term “network element,” as used herein, refers to physical or virtualized equipment or infrastructure used to provide wired or wireless communication network services. The term “network element” may be considered synonymous with or referred to as a networked computer, networking hardware, network equipment, network node, virtualized network function, or the like.

The term “information element” refers to a structural element containing one or more fields. The term “field” refers to individual contents of an information element or a data element that contains content. An information element may include one or more additional information elements.

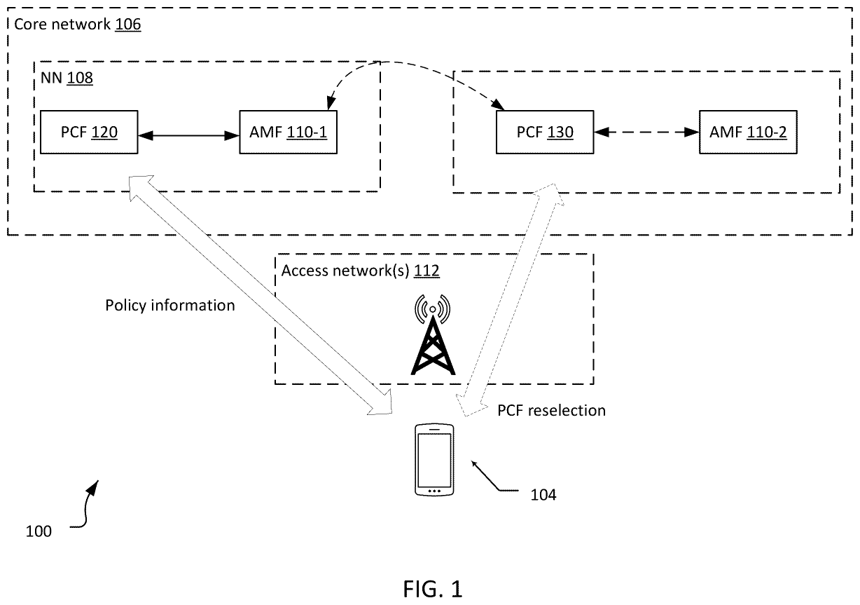

FIG. 1 illustrates a network environment 100 in accordance with some embodiments. The network environment 100 may include a UE 104 coupled with a network node (NN) 108. The NN 108 may include one or more functions of a core network 106. For example, the NN 108 may include an access and mobility management function (AMF) 110 and a policy control function (120). In some embodiments, the UE 104 may be coupled to the NN 108 through an access network 112 having a next-generation node B (gNB) that provides one or more 3GPP New Radio (NR) cells or an evolved node B (eNB) that provides one or more Long Term Evolution (LTE) cells. The access network 112 may represent one or more radio access networks (RANs). The air interface over which the UE 104 communicates with the access network 112 may be compatible with 3GPP technical specifications (TSs), such as those that define Fifth Generation (5G) NR or later system standards (e.g., Sixth Generation (6G) standards).

The AMF 110 may be responsible for handling the connection and mobility management tasks of the UE 104. For example, AMF 110 may communicate with the UE 104 at initial registration or manage handovers between different cells. The AMF 110 may handle non-access stratum (NAS) messages from the UE over the N1 interface. The AMF 110 follows the service-based architecture (SBA) in which the AMF 110 provides services to other network functions through service-based interfaces (SBIs). The AMF 110 interface to other network functions may be referred to as Namf.

The PCF 120 may provide policy rules for the UE 104, e.g., access network discovery and selection policy (ANDSP), UE route selection policy (URSP), vehicle-to-everything (V2X), or proximity services (ProSe). The policy rules may include rules for control or user plane. The PCF 120 may provide services to other network functions through its service-based interface. The PCF 120 interface to other network functions may be called Npcf.

The UE 104 and the PCF 120 may exchange policy configuration information during the initial registration procedure. For example, the UE 104 may provide the PCF 120 with a list of one or more UE policy section identifiers (UPSIs). In one instance, the UE may send the UE SET INDICATION message to the PCF 120. The message may be transparently forwarded by the AMF 110. In response to the list of UPSIs from the UE 104, the PCF 120 may provide each UE policy using one or more UE policy sections identified by the UPSIs. The PCF 120 may provide the UE 104 with its policies using the network-requested UE policy management procedure.

The UE 104 may also provide an indication that it supports access network discovery and selection policy (ANDSP). For example, in some instances, the operators may use ANDSP to control how devices select, access, and utilize a wireless local area network. The UE 104 may also provide an operating system (OS) identification (ID). The OSId identifies the operating system supported by the UE 104 and enables the PCF 120 to send the correct policy to the UE 104 for OS-dependent policies.

The PCF 120 may send policy updates to the UE 104. For example, the PCF 120 may instruct the UE 104 to delete some policy sections. The PCF 120 may instruct the UE 104 to update or add some policy sections.

After initial registration, the AMF 110 may reselect a new PCF, e.g., the PCF 130. For example, the AMF 110 may reselect the PCF 130 due to AMF relocation, e.g., caused by the UE 104 mobility, handover, e.g., to another radio access technology (RAT), or inter-system change (transition from a Forth Generation service 4G to a Fifth Generation system 5GS). Furthermore, the reselected PCF 130 may be served with the AMF 110-1 or with a different AMF, e.g., the AMF 110-2. The AMFs 110-1 and 110-2 play a transparent, passthrough role in messages between the PCF 120, PCF 130, and the UE 104. Reference herein to AMF 110 may refer to AMF 110-1 or AMF 110-2.

In a legacy implementation, during the PCF reselection, a UE may not provide, to a reselected PCF, an indication of a list of stored policy section identifiers (PSIs), an indication of its ANDSP support, or a UE OSId. When an AMF establishes policy association between the UE and a reselected PCF, the reselected PCF may interpret that the UE is triggering a 5GS initial registration request and that the UE does not have any UE policy sections stored for the public land mobile network (PLMN) or home PLMN (HPLMN).

Not having a list of the UE's stored PSIs, the ANDSP indication, or the OSId at the reselected PCF may cause a mismatch of policy configuration between the UE and the reselected PCF. For example if, due to a previous UE policy provisioning procedure, the UE received and stored policy sections 1, 2, and 3, and the reselected PCF requires only policy sections 1 and 2. Because the reselected PCF does not have the UE's PSIs, the reselected PCF may provide the UE policy sections 1 and 3, which is unnecessary because the UE already has policy sections 1 and 3. Moreover, the reselected PCF does not have any information about policy section 2 at the UE and hence may not instruct the UE to delete or remove policy section 2. If the reselected PCF had information about the UE PSIs, it would have been sufficient to instruct the UE to delete policy section 2.

The mismatch of policy configuration between the UE and the reselected PCF may lead to the misconfiguration of policies in the UE, and the PCF may not have an accurate reflection of policies configured on the UE.

Embodiments of the present disclosure provide operations that address the mismatch of policy configuration between the UE 104 and the PCF 130, similar to that described above, with respect to legacy systems. In some embodiments, the PCF 130 may send a query and obtain the UE state indication, e.g., UPSIs, ANDSP indication, or the UE OSId, when the PCF 130 does not receive the UE state indication during the registration. The PCF 130 may send the query to the UE 104 or to the previous PCF, e.g., the PCF 120, or may obtain it from a unified data repository (UDR). In another embodiment, the NN 108 may configure the UE 104 and make it mandatory for the UE 104 to send the UE state indications. In another embodiment, the UE 104 and the PCF 130 may implement error-handling procedures to handle the instances in which a mismatch in the policy configuration between the UE 104 and the PCF 130 occurs.

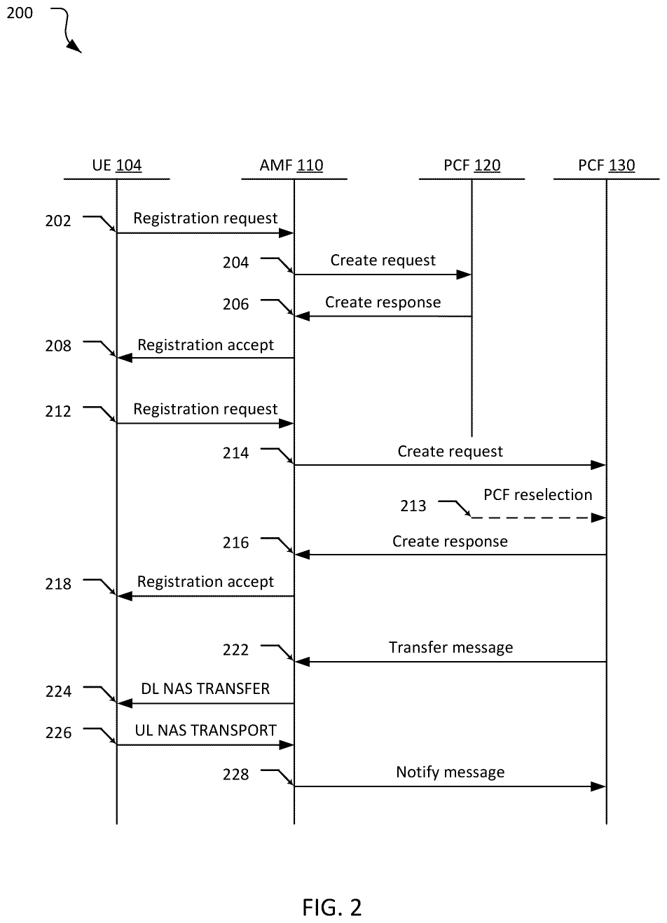

FIG. 2 illustrates a signaling diagram 200 in accordance with some embodiments. The signaling diagram 200 is an example of the reselected PCF 130 querying the UE 104 for the UE state indications.

At 202, the UE 104 sends a registration request to the AMF 110 as part of an initial registration. The UE 104 may provide the UE state indication to the PCF 120 through the registration request message. For example, the UE 104 may provide the UE state indication, e.g., UPSIs, ANDSP indicator, or its OS ID, to the PCF 120 in a UE STATE INDICATION message. In one instance, the UE 104 may encapsulate the UE STATE INDICATION message in the REGISTRATION REQUEST message that the UE 104 sends to the AMF 110 to initiate the initial registration process. The UE STATE INDICATION message may be encapsulated in a payload container information element (IE) in the REGISTRATION REQUEST message. The AMF 110 receives the UE STATE INDICATION message.

The UE 104 may include the UE STATE INDICATION message in a payload container of the REGISTRATION REQUEST message. The REGISTRATION REQUEST message may include a payload container type indication that indicates the content of the payload container is the UE STATE INDICATION message.

At 204, the AMF 110 forwards a create request message to the PCF 120. The create request message may be a UE policy control create request message transmitted over an Npcf interface (e.g., an Npcf_UEPolicyControl_CreateRequest message). The create request message may include the UE STATE INDICATION message or portions thereof, e.g., the UE state indication. The AMF 110 creates a policy association between the UE 104 and the PCF 120.

At 206, the PCF 120 sends a create response message to the AMF 110. The create response message may be a UE policy control create response message transmitted over an Npcf interface (e.g., a Npcf_UEPolicyControl_CreateResponse message). The create response message may include the UE policy section for the UE PSIs included in the UE state indication.

At 208, the AMF 110 sends a registration accept message to the UE 104. The registration accept message may be the REGISTRATION ACCEPT message. The registration accept message may contain the UE policy section.

Due to mobility, the UE 104 may select a new RAT, move back from a 4G service to a 5G service, or select a new AMF, leading to the selection of a new PCF. This may cause the UE 104 to initiate registration with a new AMF by transmitting a REGISTRATION REQUEST message at 212 using the periodic and mobility registration procedure. However, the UE 104 may not include the UE STATE INDICATION message in the REGISTRATION REQUEST message sent as part of the periodic and mobility registration procedure.

At 214, the AMF 110 sends a create request message to the PCF 130. The create request message may be a UE policy control create request message transmitted over an Npcf interface (e.g., a Npcf_UEPolicyControl_CreateRequest message). The create request message may not include the UE state indication information.

At 213 PCF, the reselection process is completed.

At 216, the PCF 130 sends a create response message to the AMF 110. The create response message may be a UE policy control create response message transmitted over an Npcf interface (e.g., a Npcf_UEPolicyControl_CreateResponse message). However, because the create request message at 214 did not include the UE state indication, the create response message may not include the UE policy sections for the UE.

At 218, the AMF 110 sends a registration accept message to the UE 104. The registration accept message may be the REGISTRATION ACCEPT message. However, because the PCF 130 at 216 did not send the UE policy section, the registration accept message may not contain the UE policy section.

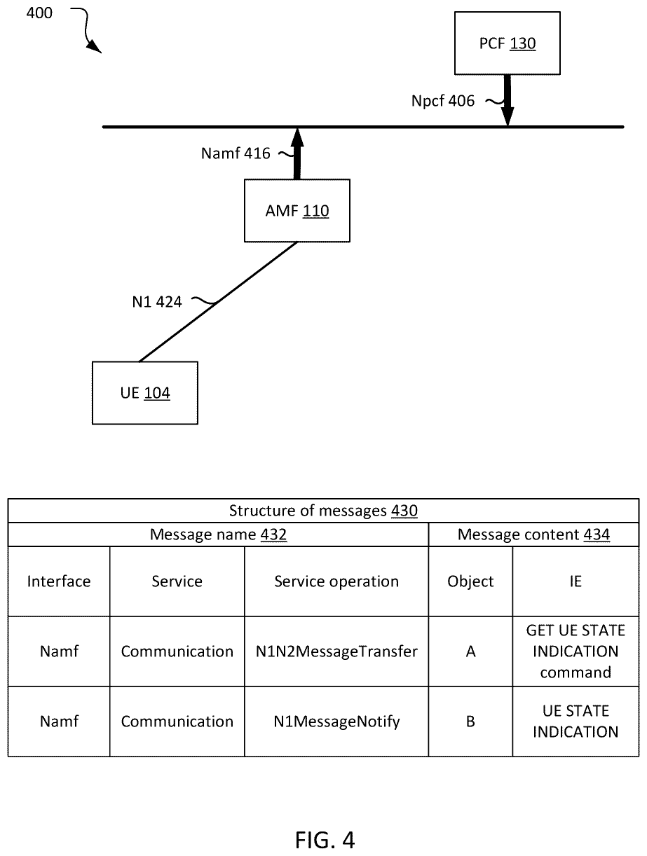

Given that the PCF 130 did not receive the UE state information in the create request message at 214, it may, sometime after the PCF reselection is complete at 213, send a message at 222 to query the UE 104 for UE state information. The message may be a communication message transmitted over an Namf interface to transfer N1 or N2 information (e.g., an Namf_Communication_NIN2MessageTransfer message). N1 and N2 information is described in further detail with respect to FIG. 4. The message may be transmitted to the AMF 110 and may include a GET UE STATE INDICATION message that is to be forwarded to the UE 104. The GET UE STATE INDICATION message may include a command, e.g., a GET UE STATE INDICATION, to request the UE state information.

At 224, the AMF 110 forwards a transfer message to the UE 104. The transfer message may be sent in the downlink (DL) NAS TRANSPORT message. The transfer message may include a command sent by the PCF 130 to the UE 104, e.g., the GET UE STATE INDICATION command. The transfer message may include a payload container type indication indicating that the payload container's content is the GET UE STATE INDICATION command.

At 226, the UE 104 sends a message to the AMF 110. The message may be sent in the uplink (UL) NAS TRANSPORT message. The transport message may include a message from the UE 104 to the PCF 130 containing the UE state indication, e.g., the UE STATE INDICATION message. The transport message may include a payload container type indication that indicates the content of the payload container is the UE STATE INDICATION message.

At 228, the AMF 110 sends a notify message to the PCF 130. The notify message may be a communication N1 message notify message transmitted over an Namf interface (e.g., an Namf_Communication_N1MessageNotify message). The notify message may include the UE STATE INDICATION message or portions thereof, e.g., the UE state indication.

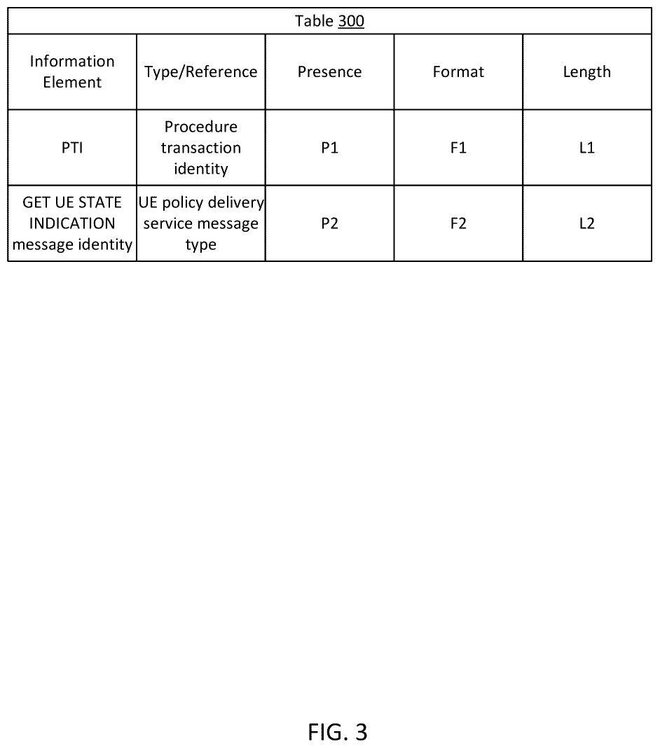

FIG. 3 illustrates the table 300 in accordance with some embodiments. Table 300 is an example of the content of the GET UE STATE INDICATION message that the PCF 130 sends to query and obtain the UE state indication.

The GET UE STATE INDICATION message may have, for example, a procedure transaction identity (PTI) IE and a message identity IE (e.g., GET UE STATE INDICATION message identity IE). The PTI is used as a unique identifier for the message that is sent to the UE 104. For example, when the UE 104 receives the command, the UE 104 may use the same PTI in response to the PCF 130. The PTI would associate the response to the command at the PCF 130.

The column type/reference describes the IE type and may also reference the relevant sections of the 3GPP technical specifications. The presence column indicates whether the use of the field is mandatory or optional. For example, a value of ‘M’ indicates that the field is mandatory and cannot be omitted. In one example, the use of PTI is mandatory in the GET UE STATE INDICATION command. The format column indicates the format by which the IE is presented. For example, a value of ‘V’ indicates that a value represents the IE. A value may represent the PTI. The column length indicates the number of bytes allocated for the IE. For example, a value of ‘1’ indicates that the IE is 1 byte. The PTI for the GET UE STATE INDICATION command may be 1 byte.

The message identity IE may include a type/reference column that indicates that a command of the GET UE STATE INDICATION message is for a UE policy delivery service message. In one instance, the presence column for the message identity may have the value ‘M,’ indicating that the message identity field is mandatory. The column format may have the value ‘V,’ and the length of the IE may be ‘1’ byte.

FIG. 4 illustrates a block diagram 400 in accordance with some embodiments. Block diagram 400 is an example of the SBA and SBI. The two network functions, PCF 130 and AMF 110 are coupled with each other in the core network and coupled with the UE 104 via the access network. The PCF 130 may use interface 406 to be reached by or to access other network functions. The interface 406 may be called the Npcf interface.

The AMF 110 may use the interface 416 to be reached by or to access other network functions. The interface 416 may be called the Namf interface. The AMF 110 is connected to the UE 104 through the interface 424. The interface 424 may be called the N1 interface.

Table 430 shows the structure of a message, including the structure of a message name 432 and structure of message content 434. The message name 432 may include three parts. The first part may indicate the interface with which the message is associated. The second part may indicate the service provided by the network function generating or sending the message. The third part of the message name 432, may include a service operation provided by the network function. For example, the Namf_Communication_NIN2MessageTransfer is a message on the Namf interface for the message transfer operation of the communication service provided by the AMF. Moreover, the message is a message transfer service operation of the communication service related to the N1 and N2 (interface between the AMF and the base station) interfaces.

Similarly, Namf_Communication_NIMessageNotify is a message on the Namf interface of a notification service operation provided by the communication service of the AMF. The specific service operation is a notification message on the N1 interface. This structure and naming may apply to other messages herein.

The message content 434 may include one or more objects, and each object may include one or more IEs. For example, the Namf_Communication_NIN2MessageTransfer message may include the PCF 130 GET UE STATE INDICATION command in an IE of the object ‘A.’ Similarly, the AMF may include the UE STATE INDICATION message in an IE of an object ‘B’ of the Namf_Communication_N1MessageNotify message.

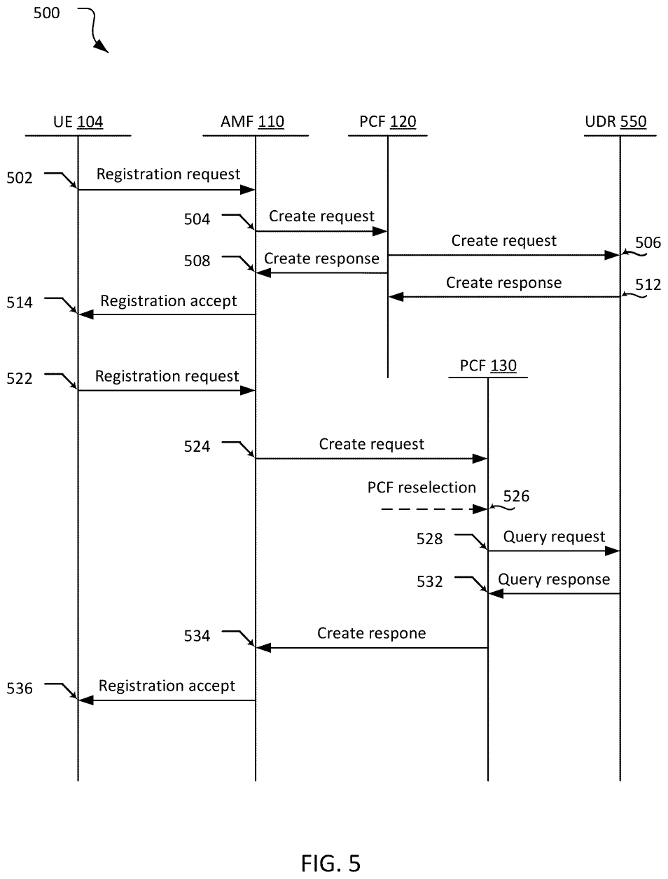

FIG. 5 illustrates a signaling diagram 500 in accordance with some embodiments. Signaling diagram 500 is an example of PCF 130 querying the unified data repository (UDR) 550 to obtain the UE state indication.

At 502, the initial registration, the operation is similar to 202 in FIG. 2. The UE 104 sends a registration request to the AMF 110. The registration request message may be sent in the REGISTRATION REQUEST message. The registration request message may include a message from the UE 104 to the PCF 130 containing the UE state indication, e.g., the UE STATE INDICATION message. The registration request message may include a payload container type indication that indicates the content of the payload container is the UE STATE INDICATION message.

At 504, the AMF 110 forwards a create request message to the PCF 120. The create request message may be a UE policy control create request message transmitted over an Npcf interface (e.g., an Npcf_UEPolicyControl_CreateRequest message). The create request message may include the UE STATE INDICATION message or portions thereof, e.g., the UE state indication. The AMF 110 creates a policy association between the UE 104 and the PCF 120.

At 506, the PCF 120 may send a create request message to the UDR 550. The create request message may be a data management (DM) create request message or a DM update message over the Nudr interface (e.g., a Nudr_DM_CreateRequest or a Nudr_DM_Update message). The create request message may include the UE state indication information. The UDR 550 may store the UE state indication information.

The PCF 120 may send instructions to the UE 104 to update, add, or delete policy sections. The PCF 120 may update the UE state information stored at the UDR 550 with a procedure similar to the one described above.

If the subsequent PCFs do not receive the UE state indication during the initial registration, they may query the UDR 550 and obtain the UE state indication from the UDR 550.

At 508, the PCF 120 sends a create response message to the AMF 110. The create response message may be a UE policy control create response message transmitted over an Npcf interface (e.g., a Npcf_UEPolicyControl_CreateResponse message). The create response message may include the UE policy sections for the UE PSIs included in the UE state indication.

At 512, the UDR 550 sends a create response to the PCF 120. The create response message may be a data management (DM) create response message transmitted over the Nudr interface (e.g., a Nudr_DM_CreateResponse message). The create response message may include an indication that the UDR 550 has stored or updated the previously stored UE state information.

At 514, the AMF 110 sends a registration accept message to the UE 104. The registration accept message may be sent in REGISTRATION ACCEPT message. The registration accept message may contain the UE policy section.

Due to mobility, the UE 104 may select a new RAT, move back from a 4G service to a 5G service, or select a new AMF, leading to the selection of a new PCF. This may cause the UE 104 to initiate registration with a new AMF by transmitting a REGISTRATION REQUEST message at 212. However, the UE 104 may not include the UE STATE INDICATION message in the REGISTRATION REQUEST message as part of the mobility and periodic registration procedure.

At 522, The UE 104 sends a registration request message to the AMF 110. The registration request message may be the REGISTRATION REQUEST message. However, the registration request message may not include the UE state indication.

At 524, the AMF 110 sends a create request message to the PCF 130. The create request message may be a UE policy control create request message transmitted over an Npcf interface (e.g., a Npcf_UEPolicyControl_CreateRequest message). However, because the UE 104 did not include the UE state indication in the registration request message, the create request message may not include the UE state indication information.

At 526, the PCF reselection process is completed.

At 528, the PCF 130 sends a query request message to the UDR 550 to obtain the UE state indication. The query request message may be a DM QueryRequest of the DM service operation transmitted over the Nudr interface (e.g., a Nudr_DM_QueryRequest message). The query request message may include indications to identify the requested information.

At 532, the UDR 550 sends a query response message to the PCF 130. The query response message may be a DM query response message transmitted over the Nudr interface (e.g., the Nudr_DM_QueryResponse message). The query response message may include the UE state indication.

At 534, the PCF 130 sends a create response message to the AMF 110. The create response message may be a UE policy control create response message transmitted over an Npcf interface (e.g., a Npcf_UEPolicyControl_CreateResponse message). The create response message may include the UE policy sections for the UE PSIs included in the UE state indication.

At 536, the AMF 110 sends a registration accept message to the UE 104. The registration accept message may be REGISTRATION ACCEPT message. The registration accept message may contain the UE policy section.

The NAS messages described here or in FIG. 2 may be similar to those described in 3GPP TS 24.501 v18.1.0 (2022-12). The PCF or AMF message described here or in FIG. 2 may be similar to that described in 3GPP TS 23.503 v18.0.0 (2022-12).

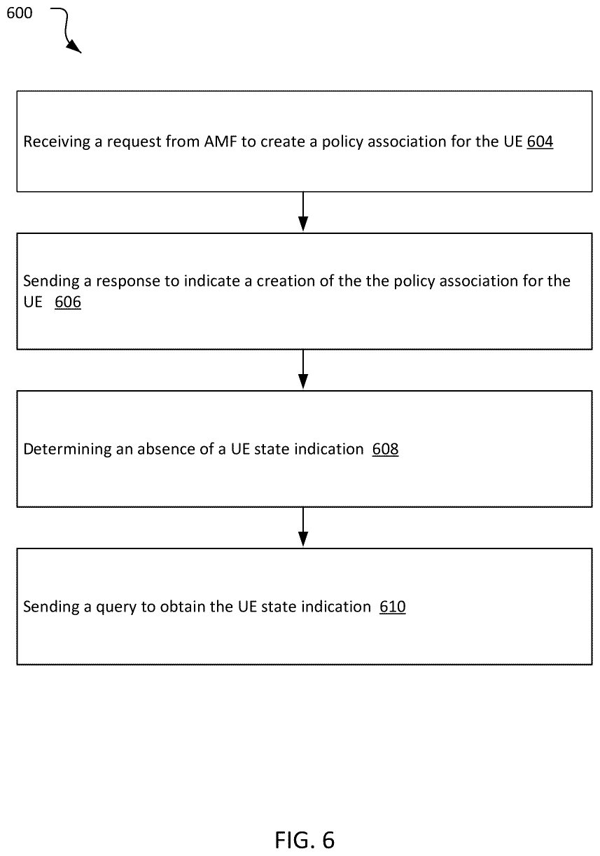

FIG. 6 illustrates an operational flow/algorithmic structure 600 in accordance with some embodiments. Operational flow/algorithmic structure 600 is an example of a PCF querying a UE to obtain the UE state information. The operational flow/algorithmic structure 700 may be implemented by a NN including a PCF, for example, NN 108, network node 1200, or components therein, e.g., processors 1204

The operational flow/algorithmic structure 600 may include, at 604, receiving a request from an AMF to create a policy association for a UE. The request may be a Npcf_UEPolicyControl_CreatRequest message encapsulating or including the UE state indication information. The UE state indication information may include the UPSIs, indication of UEs ANDSP support, or the UE OSId.

The operational flow/algorithmic structure 600 may include, at 606, sending a response to indicate the creation of the policy association for the UE. The PCF may use the Npcf_UEPolicyControl_CreateResponse message to indicate the creation of the policy association for the UE.

The operational flow/algorithmic structure 600 may include, at 608, determining an absence of a UE state indication. For example, the request from the AMF at 604 may not include the UE state indication. The PCF may determine the absence of a UE state indication at any time after 604, e.g., after receiving the Npcf_UEPolicyControl_CreateRequest.

The operational flow/algorithmic structure 600 may include, at 610, sending a query to obtain the UE state indication.

For example, the PCF may send a query to the UE to obtain the UE state indication. The query may include a command to the UE, e.g., GET UE STATE INDICATION command. The PCF may send the query to the UE through the AMF.

In another example, the PCF may query a UDR. The PCF may query the UDR on the Nudr interface. The UDR provides previously stored UE state information to the PCF.

In another example, the PCF may query the PCF with which the UE was previously associated. For example, if the UE has a policy association with PCF1, and subsequently, the UE reflects PCF2 and establishes a policy association with PCF2, PCF 2 may obtain the UE state information by querying PCF1.

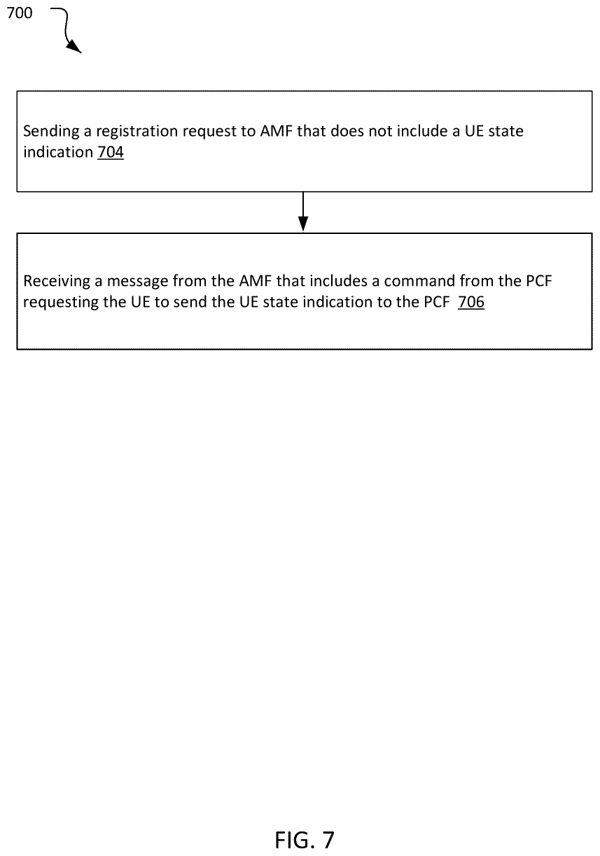

FIG. 7 illustrates an operational flow/algorithmic structure in accordance with some embodiments. Operational flow/algorithmic structure 700 is an example of operating a UE to provide UE state information to a PCF in response to a query from the PCF. The operational flow/algorithmic structure 700 may be implemented by a UE, for example, the UE 104, the UE 1100, or components therein, e.g., processors 1104.

The operational flow/algorithmic structure 700 may include, at 704, sending a registration request to AMF that does not include a UE state indication.

The operational flow/algorithmic structure 700 may include, at 706, receiving a message from the AMF that includes a command from the PCF requesting the UE to send the UE state indication to the PCF. For example, the UE may receive the message from the AMF on a DL NAS TRANSFER message.

The UE may respond to the command by sending a message, including the UE state information, to the PCF through the AMF. For example, the UE may send the UE state indication to the AMF using a NAS transport procedure, e.g., a UL NAS TRANSPORT message. AMF forwards the message to the PCF.

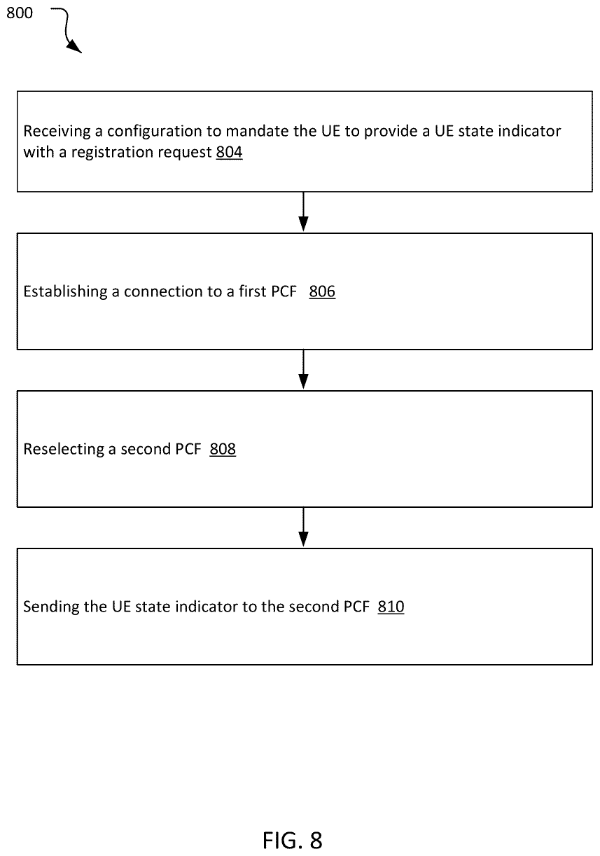

FIG. 8 illustrates an operational flow/algorithmic structure 800 in accordance with some embodiments. Operational flow/algorithmic structure 800 is an example of operating a UE to provide UE state information to a PCF. The operational flow/algorithmic structure 800 may be implemented by a UE, for example, the UE 104, the UE 1100, or components therein, e.g., processors 1104.

The operational flow/algorithmic structure 800 may include, at 804, receiving a configuration to mandate the UE to provide a UE state indication with a registration request. The configuration may be a radio resource control (RRC) signaling. In one instance, the UE may be configured at the deployment. The 3GPP standard specification may make sending the UE state indication mandatory.

The operational flow/algorithmic structure 800 may include, at 806, establishing a connection to a first PCF. The connection may include establishing a policy association between the UE and the PCF. Because of the configuration that provides for sending the UE state indication to the PCF, the UE may send the UE state indication to the first PCF.

The operational flow/algorithmic structure 800 may include, at 808, reselecting a second PCF. For example, the UE may connect to a new AMF or a new PCF due to mobility.

The operational flow/algorithmic structure 800 may include, at 810, sending a message to the second PCF. The message includes the UE state indication. Because of the configuration at 804, the UE is required to send the UE state indication to the second PCF.

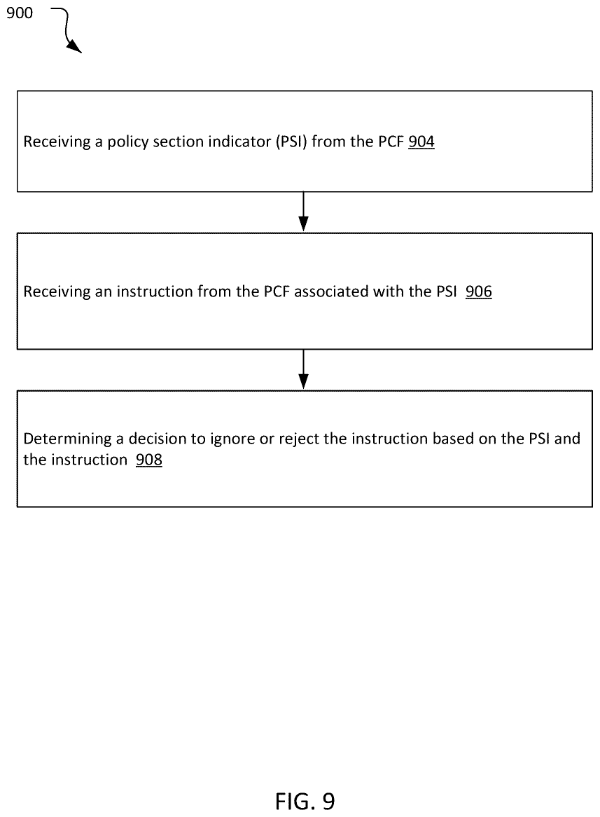

FIG. 9 illustrates an operational flow/algorithmic structure 900 in accordance with some embodiments. Operational flow/algorithmic structure 900 is an example of a UE operation for handling a mismatch between a UE and a PCF. The operational flow/algorithmic structure 900 may be implemented by a UE, for example, the UE 104, the UE 1100, or components therein, e.g., processors 1104.

The operational flow/algorithmic structure 900 may include, at 904, receiving a policy section indicator (PSI) from the PCF.

The operational flow/algorithmic structure 900 may include, at 906, receiving an instruction from the PCF. The instruction is associated with the PSI.

The operational flow/algorithmic structure 900 may include, at 908, determining a decision whether to ignore or reject the instruction based on the PSI and the instruction.

For example, if the network sends a PSI along with an instruction to delete the policy section associated with the PSI, and if the UE does not have the relevant policy section, the UE may ignore the network request.

Suppose the UE receives a plurality of PSIs and several instructions, and the UE cannot execute some of the instructions associated with some PSIs. In that case, the UE may reject those instructions and accept and execute the rest. When the UE rejects one or more instructions, the UE may inform the PCF about the failed or rejected instructions and the cause of rejection. For example, the UE may encode the UPSI associated with the rejected instruction and the cause of the failure and send them in a MANAGE UE POLICY COMMAND REJECT message. The UE may send the MANAGE UE POLICY COMMAND REJECT message using the UL NAS TRANSPORT message to the AMF.

In one instance, the UE may, after detecting an error or mismatch between the UE and the PCF on stored PSI info, send the UE state information in a mobility and periodic update registration request message so that UE and new PCF can sync up. The registration request message may be the REGISTRATION REQUEST message.

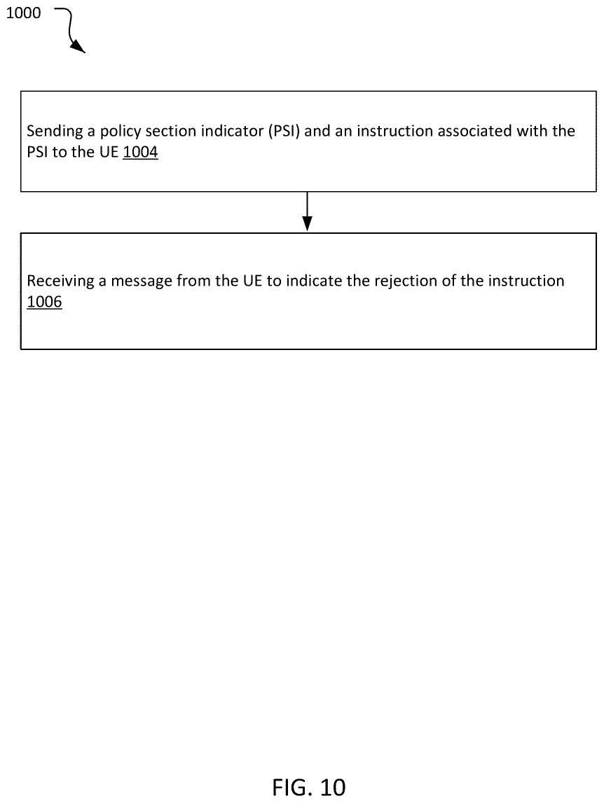

FIG. 10 illustrates an operational flow/algorithmic structure 1000 in accordance with some embodiments. Operational flow/algorithmic structure 1000 is an example of operating a PCF for handling a mismatch between a UE and the PCF. The operational flow/algorithmic structure 1000 may be implemented by an NN, for example, NN 108, network node 1200, or components therein, e.g., processors 1204

The operational flow/algorithmic structure 1000 may include, at 1004, sending a PSI and an instruction associated with the PSI to the UE.

The operational flow/algorithmic structure 1000 may include, at 1006, receiving a message from the UE indicating a rejection of the instruction. The PCF may ask the UE to send updated state indication information. For example, the PCF may send the GET UE STATE INDICATION command. In addition, the PCF may send a message to AMF to trigger UE registration, where the UE would send the UE STATE INDICATION message.

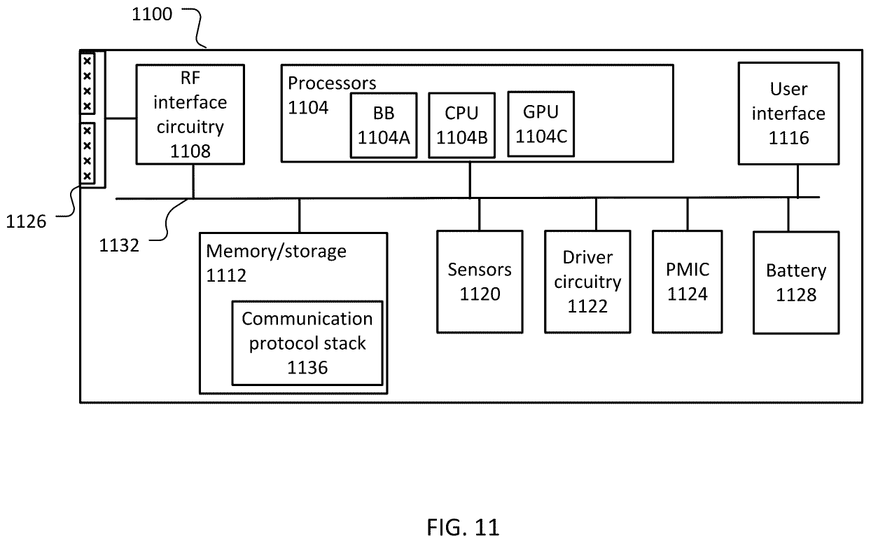

FIG. 11 illustrates a UE 1100 in accordance with some embodiments. The UE 1100 may be similar to and substantially interchangeable with UE 104 of FIG. 1.

The UE 1100 may be any mobile or non-mobile computing device, such as, for example, a mobile phone, computer, tablet, XR device, glasses, industrial wireless sensor (for example, microphone, carbon dioxide sensor, pressure sensor, humidity sensor, thermometer, motion sensor, accelerometer, laser scanner, fluid level sensor, inventory sensor, electric voltage/current meter, or actuator), video surveillance/monitoring device (for example, camera or video camera), wearable device (for example, a smartwatch), or Internet-of-things device.

The UE 1100 may include processors 1104, RF interface circuitry 1108, memory/storage 1112, user interface 1116, sensors 1120, driver circuitry 1122, power management integrated circuit (PMIC) 1124, antenna structure 1126, and battery 1128. The components of the UE 1100 may be implemented as integrated circuits (ICs), portions thereof, discrete electronic devices, or other modules, logic, hardware, software, firmware, or a combination thereof. The block diagram of FIG. 11 is intended to show a high-level view of some of the components of the UE 1100. However, some of the components shown may be omitted, additional components may be present, and different arrangements of the components shown may occur in other implementations.

The components of the UE 1100 may be coupled with various other components over one or more interconnects 1132, which may represent any type of interface, input/output, bus (local, system, or expansion), transmission line, trace, or optical connection that allows various circuit components (on common or different chips or chipsets) to interact with one another.

The processors 1104 may include processor circuitry such as, for example, baseband processor circuitry (BB) 1104A, central processor unit circuitry (CPU) 1104B, and graphics processor unit circuitry (GPU) 1104C. The processors 1104 may include any type of circuitry, or processor circuitry that executes or otherwise operates computer-executable instructions, such as program code, software modules, or functional processes from memory/storage 1112 to cause the UE 1100 to perform operations as described herein.

The processors 1104 may perform operations associated with UE policy association with a PCF. For example, the processors 1104 may receive a request from the PCF to send the UE state indication to the PCF in response to the request, and the processors 1104 may send the UE state indication to the PCF.

In some embodiments, the baseband processor circuitry 1104A may access a communication protocol stack 1136 in the memory/storage 1112 to communicate over a 3GPP-compatible network. In general, the baseband processor circuitry 1104A may access the communication protocol stack 1136 to: perform user plane functions at a PHY layer, MAC layer, RLC sublayer, PDCP sublayer, SDAP sublayer, and upper layer; and perform control plane functions at a PHY layer, MAC layer, RLC sublayer, PDCP sublayer, RRC layer, and a NAS layer. In some embodiments, the PHY layer operations may additionally/alternatively be performed by the components of the RF interface circuitry 1108.

The baseband processor circuitry 1104A may generate or process baseband signals or waveforms that carry information in 3GPP-compatible networks. In some embodiments, the waveforms for NR may be based on the cyclic prefix OFDM (CP-OFDM) in the uplink or downlink, and discrete Fourier transform spread OFDM (DFT-S-OFDM) in the uplink.

The memory/storage 1112 may include one or more non-transitory, computer-readable media that includes instructions (for example, the communication protocol stack 1136) that may be executed by one or more of the processors 1104 to cause the UE 1100 to perform various operations described herein. The memory/storage 1112 includes any type of volatile or non-volatile memory that may be distributed throughout the UE 1100. In some embodiments, some of the memory/storage 1112 may be located on the processors 1104 themselves (for example, L1 and L2 cache), while other memory/storage 1112 is external to the processors 1104 but accessible thereto via a memory interface. The memory/storage 1112 may include any suitable volatile or non-volatile memory such as, but not limited to, dynamic random access memory (DRAM), static random access memory (SRAM), erasable programmable read-only memory (EPROM), electrically erasable programmable read-only memory (EEPROM), Flash memory, solid-state memory, or any other type of memory device technology.

The RF interface circuitry 1108 may include transceiver circuitry and a radio frequency front module (RFEM) that allows the UE 1100 to communicate with other devices over a radio access network. The RF interface circuitry 1108 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna structure 1126 and proceed to filter and amplify (with a low-noise amplifier) the signal. The signal may be provided to a receiver of the transceiver that down-converts the RF signal into a baseband signal that is provided to the baseband processor of the processor 1104.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1126.

In various embodiments, the RF interface circuitry 1108 may be configured to transmit/receive signals in a manner compatible with NR access technologies.

The antenna 1126 may include antenna elements to convert electrical signals into radio waves to travel through the air and to convert received radio waves into electrical signals. The antenna elements may be arranged into one or more antenna panels. The antenna 1126 may have antenna panels that are omnidirectional, directional, or a combination thereof to enable beamforming and multiple input, multiple output communications. The antenna 1126 may include microstrip antennas, printed antennas fabricated on the surface of one or more printed circuit boards, patch antennas, or phased array antennas. The antenna 1126 may have one or more panels designed for specific frequency bands, including bands in FR1 or FR2.

The user interface circuitry 1116 includes various input/output (I/O) devices designed to enable user interaction with the UE 1100. The user interface 1116 includes input device circuitry and output device circuitry. Input device circuitry includes any physical or virtual means for accepting an input, including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual displays, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 1100.

The sensors 1120 may include devices, modules, or subsystems whose purpose is to detect events or changes in its environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 1122 may include software and hardware elements that control particular devices embedded in the UE 1100, attached to the UE 1100, or otherwise communicatively coupled with the UE 1100. The driver circuitry 1122 may include individual drivers allowing other components to interact with or control various I/O devices that may be present within or connected to the UE 1100. For example, the driver circuitry 1122 may include circuitry to facilitate the coupling of a universal integrated circuit card (UICC) or a universal subscriber identity module (USIM) to the UE 1100. For additional examples, driver circuitry 1122 may include a display driver to control and allow access to a display device, a touchscreen driver to control and allow access to a touchscreen interface, sensor drivers to obtain sensor readings of sensor circuitry 1120, and control and allow access to sensor circuitry 1120, drivers to obtain actuator positions of electro-mechanic components or control and allow access to the electro-mechanic components, a camera driver to control and allow access to an embedded image capture device, audio drivers to control and allow access to one or more audio devices.

The PMIC 1124 may manage the power provided to various components of the UE 1100. In particular, with respect to the processors 1104, the PMIC 1124 may control power-source selection, voltage scaling, battery charging, or DC-to-DC conversion.

In some embodiments, the PMIC 1124 may control or otherwise be part of various power-saving mechanisms of the UE 1100, including DRX, as discussed herein.

A battery 1128 may power the UE 1100, although, in some examples, the UE 1100 may be mounted and deployed in a fixed location and may have a power supply coupled to an electrical grid. The battery 1128 may be a lithium-ion battery, a metal-air battery, such as a zinc-air battery, an aluminum-air battery, a lithium-air battery, and the like. In some implementations, such as in vehicle-based applications, the battery 1128 may be a typical lead-acid automotive battery.

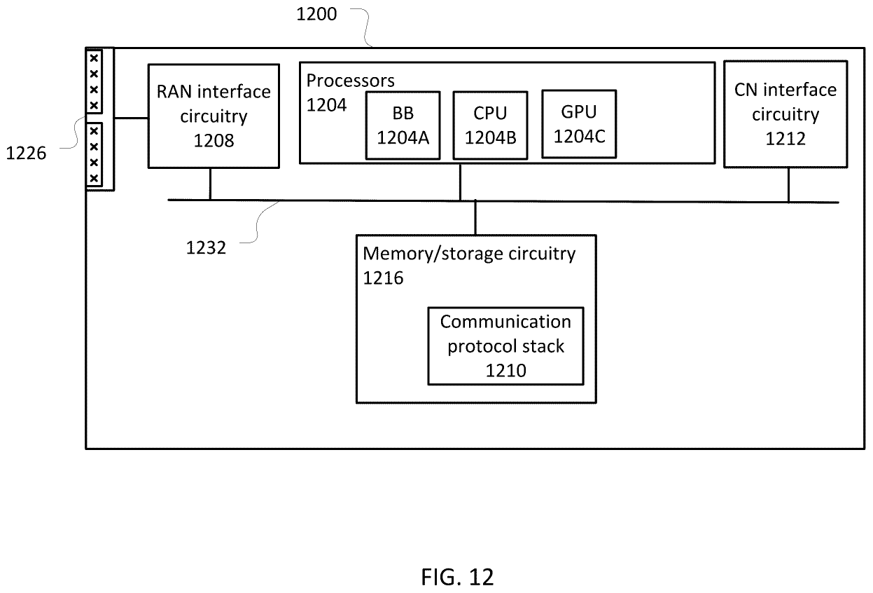

FIG. 12 illustrates a network node 1200 in accordance with some embodiments. The network node 1200 may be similar to and substantially interchangeable with base station 108, a device implementing one of the network hops, an integrated access and backhaul (IAB) node, a network-controlled repeater, or a server in a core network or external data network.

The network node 1200 may include processors 1204, RF interface circuitry 1208 (if implemented as an access node), the core node (CN) interface circuitry 1212, memory/storage circuitry 1216, and antenna structure 1226.

The components of the network node 1200 may be coupled with various other components over one or more interconnects 1232.

The processors 1204, RF interface circuitry 1208, memory/storage circuitry 1216 (including communication protocol stack 1210), the antenna structure 1226, and interconnects 1232 may be similar to like-named elements shown and described with respect to FIG. 11.

The processors 1204 may perform operations associated with establishing a policy association between a UE and the network node 1200. For example, the processors 1204 may send a query to obtain the UE state indication. The processors 1204 may send the query to the UE, a UDR, or another PCF.

The CN interface circuitry 1212 may provide connectivity to a core network, for example, a 5th Generation Core network (5GC) using a 5GC-compatible network interface protocol such as carrier Ethernet protocols or some other suitable protocol. Network connectivity may be provided to/from the network node 1200 via a fiber optic or wireless backhaul. The CN interface circuitry 1212 may include one or more dedicated processors or FPGAs to communicate using one or more of the aforementioned protocols. In some implementations, the CN interface circuitry 1212 may include multiple controllers to provide connectivity to other networks using the same or different protocols.

In some embodiments, the network node 1200 may be coupled with transmit-receive points (TRPs) using the antenna structure 1226, CN interface circuitry, or other interface circuitry.

It is well understood that the use of personally identifiable information should follow privacy policies and practices that are generally recognized as meeting or exceeding industry or governmental requirements for maintaining the privacy of users. In particular, personally identifiable information data should be managed and handled to minimize risks of unintentional or unauthorized access or use, and the nature of authorized use should be clearly indicated to users.

For one or more aspects, at least one of the components set forth in one or more of the preceding figures may be configured to perform one or more operations, techniques, processes, or methods as set forth in the example section below. For example, the baseband circuitry, as described above in connection with one or more of the preceding figures, may be configured to operate in accordance with one or more of the examples set forth below. For another example, circuitry associated with a UE, base station, network element, etc., as described above in connection with one or more of the preceding figures, may be configured to operate in accordance with one or more of the examples set forth below in the example section.

### Examples

In the following sections, further exemplary aspects are provided.

Example 1 includes a method of operating a policy control function (PCF) for updating policies of a user equipment (UE), the method including: receiving a request from an access and mobility management function (AMF) to create a policy association for the UE; sending, based on the request from the AMF, a response to indicate a creation of the policy association for the UE; determining an absence of a UE state indication having a UE policy section identifier (UPSI), an access network discovery and selection policy (ANDSP) indicator, or an operating system (OS) identifier; and sending, based on said determining the absence of the UE state indication, a query to obtain the UE state indication.

Example 2 includes the method of example 1 or some other examples herein, wherein sending the query comprises: sending the query from the PCF to the UE via a message sent to the AMF, wherein the message includes a command to the UE.

Example 3 includes the method of any of examples 1 or 2 or some other examples herein, wherein the message is sent based on a service operation of a service provided by an interface of the AMF to transfer the message from the PCF to the UE.

Example 4 includes the method of any of examples 1-3 or some other examples herein, wherein the interface is an Namf interface, the service is a communication service, or the service operation is a message transfer operation on an N1 interface.

Example 5 includes the method of any of examples 1˜4 or some other examples herein, wherein the command is to request the UE to send the UE state indication to the PCF.

Example 6 includes the method of any of examples 1-5 or some other examples herein, wherein the message is a first message, and the method further includes: receiving from the AMF a second message in response to the query.

Example 7 includes the method of any of examples 1-6 or some other examples herein, wherein the second message is a message of a notification service operation of a communication service provided by an interface of the AMF to PCF used to notify the PCF of a communication from the UE.

Example 8 includes the method of any of examples 1-7 or some other examples herein, wherein sending the query includes: sending the query from the PCF to a unified data repository (UDR) on an interface between the PCF and the UDR.

Example 9 includes the method of any of examples 1-8 or some other examples herein, the method further including: receiving from the UDR a message based on the query, the message is to include the UE state indication.

Example 10 includes the method of any of examples 1-9 or some other examples herein, wherein the PCF is a first PCF, sending the query includes: sending the query from the first PCF to a second PCF with which the UE was previously associated.

Example 11 includes the method of any of examples 1-10 or some other examples herein, further including: receiving a message from the second PCF based on the query, the message is to include the UE state indication.

Example 12 includes a method of operating a user equipment (UE) for updating policies of the UE at a policy control function (PCF), the method including: sending, by the UE to an access and mobility management function (AMF), a registration request that does not include a UE state indication having a UE policy section identifier (UPSI), an access network discovery and selection policy (ANDSP) indicator, or an operating system (OS) identifier; and receiving, in a message from the AMF, a command from the PCF to request the UE to send the UE state indication to the PCF.

Example 13 includes the method of example 12 or some other examples herein, the method further including: sending a response based on the command from the PCF, the response including the UE state indication, said sending the response is to use a non-access stratum transport procedure.

Example 14 includes a method of operating a user equipment (UE) for updating policies of the UE at a policy control function (PCF), the method including: receiving a configuration to mandate the UE to provide a UE state indication with a registration request, the UE state indication having a UE policy section identifier (UPSI), an access network discovery and selection policy (ANDSP) indicator, or an operating system (OS) identifier; establishing a connection to a first PCF; reselecting a second PCF; and sending a message to the second PCF, the message includes the UE state indication.

Example 15 includes the method of example 14 or some other examples herein, wherein the configuration is a radio resource control (RRC) configuration.

Example 16 includes a method of operating a user equipment (UE) for handling mismatch between the UE and a policy control function (PCF), the method including: receiving a policy section indicator (PSI) from the PCF; receiving an instruction from the PCF associated with the PSI; and determining a decision to either ignore or reject the instruction based on the PSI and the instruction.

Example 17 includes the method of example 16 or some other examples herein, wherein the instruction is to delete a policy section based, the method further includes: determining an absence of the policy section; and ignoring the instruction.

Example 18 includes the method of any of examples 16 or 17 or some other examples herein, further including: determining a failure to execute the instruction; and rejecting the instruction.

Example 19 includes the method of any of examples 16-18 or some other examples herein, further including: encoding the PSI associated with the rejected instruction; and sending a message to the PCF using a non-access stratum transport procedure, the message including said encoding, or an indication of a cause of the said rejecting.

Example 20 includes the method of any of examples 16-19 or some other examples herein, further including: sending a message to the PCF, the message including a UE policy section identifier (UPSI), an access network discovery and selection policy (ANDSP) indicator, or an operating system (OS) identifier.

Example 21 includes a method of operating a policy control function (PCF) for handling mismatch between a user equipment (UE) the PCF, the method including: sending a policy section indicator (PSI) and an instruction associated with the PSI to the UE; receiving a message from the UE, the message is to indicate a rejection of the instruction;

Example 22 includes the method example 21 or some other examples herein, further including: sending a request to the UE based on the message to request an update of a UE state indication, the UE state indication includes a UE policy section identifier (UPSI), an access network discovery and selection policy (ANDSP) indicator, or an operating system (OS) identifier.

Example 23 includes the method of any of examples 21 or 22 or some other examples herein, further including: sending a request to an access and mobility management function (AMF) based on the message, the request is to trigger a registration process of the UE; and receiving a UE state indication based on the request from the UE, the UE state indication includes a UE policy section identifier (UPSI), an access network discovery and selection policy (ANDSP) indicator, or an operating system (OS) identifier.

Another example may include an apparatus comprising logic, modules, or circuitry to perform one or more elements of a method described in or related to any of examples 1-22, or any other method or process described herein.

Another example may include a method, technique, or process as described in or related to any of examples 1-23, or portions or parts thereof.

Another example may include an apparatus comprising: one or more processors and one or more computer-readable media comprising instructions that, when executed by the one or more processors, cause the one or more processors to perform the method, techniques, or process as described in or related to any of examples 1-23, or portions thereof.

Another example includes a signal as described in or related to any of examples 1-23, or portions or parts thereof.

Another example may include a datagram, information element, packet, frame, segment, PDU, or message as described in or related to any of examples 1-23, or portions or parts thereof, or otherwise described in the present disclosure.

Another example may include a signal encoded with data as described in or related to any of examples 1-23, or portions or parts thereof, or otherwise described in the present disclosure.

Another example may include a signal encoded with a datagram, IE, packet, frame, segment, PDU, or message as described in or related to any of examples 1-23, or portions or parts thereof, or otherwise described in the present disclosure.

Another example may include an electromagnetic signal carrying computer-readable instructions, wherein execution of the computer-readable instructions by one or more processors is to cause the one or more processors to perform the method, techniques, or process as described in or related to any of examples 1-23, or portions thereof.

Another example may include a computer program comprising instructions, wherein execution of the program by a processing element is to cause the processing element to carry out the method, techniques, or process as described in or related to any of examples 1-23 or portions thereof.

Another example may include a signal in a wireless network, as shown and described herein.

Another example may include a method of communicating in a wireless network, as shown and described herein.

Another example may include a system for providing wireless communication, as shown and described herein.

Another example may include a device for providing wireless communication, as shown and described herein.

Unless explicitly stated otherwise, any of the above-described examples may be combined with any other example (or combination of examples). The foregoing description of one or more implementations provides illustration and description but is not intended to be exhaustive or to limit the scope of aspects to the precise form disclosed. Modifications and variations are possible in light of the above teachings or may be acquired from the practice of various aspects.

Although the aspects above have been described in considerable detail, numerous variations and modifications will become apparent to those skilled in the art once the above disclosure is fully appreciated. It is intended that the following claims be interpreted to embrace all such variations and modifications.

What is claimed is:

1. One or more non-transitory computer-readable media having instructions that, when executed, cause processing circuitry to:
process a request from an access and mobility management function (AMF) to create a policy association for a user equipment (UE);
generate, based on the request from the AMF, a response to indicate a creation of the policy association for the UE;
determine an absence of a UE state indication having a UE policy section identifier (UPSI), an access network discovery and selection policy (ANDSP) indicator, or an operating system (OS) identifier; and
generate, based on said determination of the absence of the UE state indication, a query to obtain the UE state indication.

2. The one or more non-transitory computer-readable media of claim 1, wherein the instructions, when executed, further cause the processing circuitry to:
generate a message that includes the query and a command to the UE, the message to be sent from a policy control function (PCF) to the UE via the AMF.

3. The one or more non-transitory computer-readable media of claim 2, wherein the message is to be sent based on a service operation of a service provided by an interface of the AMF to transfer the message from the PCF to the UE.

4. The one or more non-transitory computer-readable media of claim 3, wherein the interface is an Namf interface, the service is a communication service, or the service operation is a message transfer operation on an N1 interface.

5. The one or more non-transitory computer-readable media of claim 2, wherein the command is to request the UE to send the UE state indication to the PCF.

6. The one or more non-transitory computer-readable media of claim 2, wherein the message is a first message, and the instructions, when executed, further cause the processing circuitry to:
process a second message received from the AMF in response to the query, wherein the second message is of a notification service operation of a communication service provided by an interface of the AMF to PCF used to notify the PCF of a communication from the UE.

7. The one or more non-transitory computer-readable media of claim 1, wherein the query is to be sent from a policy control function (PCF) to a unified data repository (UDR) on an interface between the PCF and the UDR.

8. The one or more non-transitory computer-readable media of claim 7, wherein the instructions, when executed, cause the processing circuitry to:
process a message received from the UDR based on the query, wherein the message is to include the UE state indication.

9. The one or more non-transitory computer-readable media of claim 1, wherein the query is to be sent from a first policy control function (PCF) to a second PCF with which the UE was previously associated.

10. The one or more non-transitory computer-readable media of claim 9, wherein the instructions, when executed, further cause the processing circuitry to:
process a message received from the second PCF based on the query, wherein the message is to include the UE state indication.

11. A method comprising:
processing a policy section indicator (PSI) received from a policy control function (PCF);
processing an instruction received from the PCF associated with the PSI; and
determining a decision to either ignore or reject the instruction based on the PSI and the instruction.

12. The method of claim 11, wherein the instruction is to delete a policy section and the method further comprises:
determining an absence of the policy section; and
ignoring the instruction.

13. The method of claim 11 further comprising:
determining a failure to execute the instruction; and
rejecting the instruction.

14. The method of claim 13 further comprising:
encoding the PSI associated with the rejected instruction to generate encoded PSI; and
generating a message to be sent to the PCF using a non-access stratum transport procedure, the message including the encoded PSI, or an indication of a cause of said rejecting the instruction.

15. The method of claim 13 further comprising:
generating a message to be sent to the PCF, the message including a UE policy section identifier (UPSI), an access network discovery and selection policy (ANDSP) indicator, or an operating system (OS) identifier.

16. An apparatus comprising:
processing circuitry to:
process a policy section indicator (PSI) received from a policy control function (PCF);
process an instruction received from the PCF associated with the PSI; and
determine a decision to either ignore or reject the instruction based on the PSI and the instruction; and
interface circuitry coupled with the processing circuitry, the interface circuitry to communicatively couple the processing circuitry with a component.

17. The apparatus of claim 16, wherein the instruction is to delete a policy section, and the processing circuitry is further to:
determine an absence of the policy section; and
ignore the instruction.

18. The apparatus of claim 16, wherein the processing circuitry is further to:
determine a failure to execute the instruction; and
reject the instruction.

19. The apparatus of claim 18, wherein the processing circuitry further to:
encode the PSI associated with the rejected instruction to generate encoded PSI; and
generate a message to be sent to the PCF using a non-access stratum transport procedure, the message including the encoded PSI, or an indication of a cause of rejection of the instruction.

20. The apparatus of claim 18, wherein the processing circuitry is further to:
generate a message to be sent to the PCF, the message including a UE policy section identifier (UPSI), an access network discovery and selection policy (ANDSP) indicator, or an operating system (OS) identifier.
